(19) United States
(12) Patent Application Publication
(10) Pub. No.: US 2026/0063798 A1
(43) Pub. Date: Mar. 5, 2026

(54) DEPTH-SURFACE IMAGING DEVICE FOR REGISTERING ULTRASOUND IMAGES TO EACH OTHER AND TO SURFACE IMAGES BY USING SURFACE INFORMATION

(71) Applicant: DERMUS KFT, Budapest (HU)

(72) Inventors: Miklós GYÖNGY, Budapest (HU); Krisztián FÜZESI, Budapest (HU); Gergely CSÁNY, Budapest (HU); Gergo SZIKSZAY-MOLNÁR, Budapest (HU)

(73) Assignee: DERMUS KFT, Budapest (HU)

(21) Appl. No.: 19/380,436

(22) Filed: Nov. 5, 2025

Related U.S. Application Data
(63) Continuation-in-part of application No. 18/561,875, now abandoned.

(30) Foreign Application Priority Data
May 20, 2021 (HU) P2100200

(51) Int. Cl. G01S 15/89; G01S 7/521; G01S 15/86

(52) U.S. Cl. CPC G01S 15/8993; G01S 7/521; G01S 15/86

(57) ABSTRACT

A multimodal imaging unit for depth-surface imaging of a skin region of interest includes an ultrasound imaging transceiver, an optically transparent acoustic deflector, an optical module, and an optical camera sensor. An ultrasound beam emitted towards the acoustic deflector is deflected towards the skin region of interest, and an ultrasound beam reflected from the skin region of interest is returned to the ultrasound imaging transceiver. An optical beam from the optical module is passed through the acoustic deflector to a skin area of the skin region of interest and an optical beam reflected from the skin area is returned to an optical camera sensor through the acoustic deflector. The transceiver and the acoustic deflector are surrounded by an intermediary coupling medium and are hermetically enclosed by a cover provided with an acoustically and optically transparent access port for the ultrasound beams and the optical beams.

### CROSS-REFERENCE TO RELATED APPLICATIONS

This application is a continuation-in-part of U.S. application Ser. No. 18/561,875, filed Nov. 17, 2023, which in turn is a National Stage of PCT/HU2022/050026, filed Mar. 28, 2022, and claims priority to Hungarian Application No. HU P2100200, filed May 20, 2021. The entire disclosure of the aforementioned applications is incorporated herein by reference in their entirety.

### TECHNICAL FIELD

The present invention relates to a depth-surface imaging device, comprising a multimodal imaging unit, which contains an in-depth imaging transceiver unit, especially an ultrasound transceiving transducer unit or an OCT transceiver unit, which is optionally movable; a transparent acoustic deflector; an intermediary media that allows pulses to propagate between the depth imaging transducer unit and the tissue object to be inspected in both directions with minimal distortion, and which allows propagation of the optical beams between the tissue object to be inspected and the camera; and a cover, hermetically enclosing the previously mentioned elements. The depth-surface imaging device also comprises an optical camera sensor outside of the cover; an optical module mounted to the optical camera sensor; an input device for controlling the depth-surface imaging device, a data transmission device, with which the data can be transmitted to an information technology display device, where they are displayed, and the images obtained can be further processed and used; and a display unit, where the images can be projected and analysed. By combined registration of the surface and depth 2D images captured using the depth-surface imaging device, the 2D images can be aligned to each other; thus, a high precision, distortion free 3D image of the tissue object to be inspected can be created.

### BACKGROUND ART

Surgeons often need preliminary information on the tissue structure under the area affecting a surgical operation. There are imaging modalities like ultrasound imaging that non-invasively reveal the internal structure of the tissue. Nevertheless, in current practice the user capturing the ultrasound images is not able to position the ultrasound images relative to the surface, since the ultrasound transceiver head covers the inspected area; thus, the exact location of the inspection is not known.

There are solutions where the user can also gain information after removing the ultrasound transducer concerning the location where the ultrasound images were taken. Nevertheless, according to current scientific knowledge, there is no such solution that provides sufficiently exact and unambiguous location information, and does not necessitate permanent marking of the tissue (e.g. with a pen); that further, makes it possible to view the registered images later, and which is able to position several ultrasound images according to the surface coordinate system.

The above needs originate from the fact that, when planning the operation, it is necessary to achieve a proper localisation precision (typically under one mm), and unambiguous location (when estimating the localisation, there must not be several possible solutions from different places). It is also a requirement that the ultrasound image records can be taken before the operation, even during a timely separate session. The diagnostics and the surgical operation are often performed separately, in most cases by different persons. The fact that the registered image records can be viewed at a later date also provides the advantage for the physician and the patient that they can follow the pathological lesion and the progress of its treatment. By being able to position several ultrasound images according to the surface coordinate system, it is possible to create a partial or full volumetric (3D) exploration, enabling the surgeon to remove all tissues to be removed, without harming any tissues that must be avoided.

In addition to the above needs related to surgery, precise registration of surface-depth images allows better image interpretation by comparison of a detected feature in one of the images with the corresponding location in the other image. For instance, a locally dark (hyperechoic) spot in an ultrasound (depth) image may be compared with the corresponding location on the dermoscopy (surface) image to make a determination whether the hyperechoic spot is likely part of a lesion or not. This interpretation aid is particularly relevant for users who are not typically well accustomed to using a certain image modality, such as ultrasound imaging for dermatologists. The added information in the images that leads to better image interpretation can also analogously used to fuse information from corresponding locations or regions in the two image modalities, leading to better visualization of images for the user or even automated or semi-automated computer-aided diagnosis.

U.S. Pat. No. 6,409,669 B1 describes an ultrasound transducer assembly includes an acoustic mirror an ultrasound transducer positioned to direct a scanned ultrasound beam at the acoustic mirror, wherein the scanned ultrasound beam is reflected by the acoustic mirror to form a reflected ultrasound beam; and an actuating device for moving the acoustic mirror relative to the scanned ultrasound beam so that the reflected ultrasound beam scans a three-dimensional volume. An ultrasound matching fluid may be disposed between the ultrasound transducer and the acoustic mirror. The actuator device may be configured for rotating the acoustic mirror, translating the acoustic mirror, or rotating and translating the acoustic mirror. The acoustic mirror may have a single acoustically-reflecting surface or may be a polygon having a plurality of acoustically reflective surfaces. In this solution, the acoustic mirrors are used to create a 3D ultrasound image from the 2D images using a motor. By moving the mirror, the pressure wave can also be deflected in the elevation direction of ultrasound imaging. It is clear from the description that the intent of the invention is simply to direct the ultrasound beam in a certain manner using a mirror with high acoustic reflectivity, with no consideration being given to the optical transparency of the material, or ways to reduce optical distortion of optical imaging, since optical (or other surface-based) imaging is not a claim of this invention. Likewise, the enclosure around the mirror is not constructed in a way to ensure light can enter and escape outside it. Altogether, no accommodation is made for optical imaging, and it is not apparent how such imaging would be implemented, or how distortion in such a case could be reduced. Moreover, this invention does not solve the problem of registration of surface-depth images, and a solution with this aim cannot be deducted from trivial steps.

US 2010/0268042 A1 describes a confocal photoacoustic microscopy system that includes a laser configured to emit a light pulse, a focusing assembly configured to receive the light pulse and to focus the light pulse into an area inside an object, an ultrasonic transducer configured to receive acoustic waves emitted by the object in response to the light pulse, and an electronic system configured to process the acoustic waves and to generate an image of the area inside the object. The focusing assembly is further configured to focus the light pulse on the object in such a way that a focal point of the focusing assembly coincides with a focal point of the at least one ultrasound transducer. By using the device, image distortion can be compensated, but the structure of the device is complex, and no 2D optical image is created during its use. During its operation, the detection of blood vessels under the skin surface and the construction of the device itself is very complicated and expensive if it is feasible at all, since an acoustic lens needs to be used that does not distort optically. This invention is specifically targeted at optoacoustic imaging, during which procedure the ultrasound element is only used on receive. Its cost and complexity is considerable, and does not provide an unambiguous implementation route for generalisation to other surface-depth multimodal imaging modalities, for example optical-ultrasound imaging. Finally, the beam separator design described in the current invention cannot be deducted from it. Contrary to the implementation described in the document, the beam follows a more simple route in the implementation according to the current invention, with less reflections and lenses; therefore, especially in the case of an ultrasound beam, it is easier to apply an intermediary coupling medium (for example water) that provides sufficiently low attenuation, thus enabling high imaging resolution related to high frequency, and improving the signal-noise ratio.

WO 2019/236606 describes a hybrid NIRF/IVUS imaging probe containing i) a spatially-truncated optical lens a substantially-planar surface of which is inclined with respect to an axis to reflect light, transmitted between proximal and distal ends of the probe, internally into a body of the lens, and ii) an acoustic transducer, disposed sequentially with the optical lens on the axis of the probe, while, at the same time, the optical and electrical members of the probe transmitting the radiative and mechanical energies are parallel to one another within the housing of the probe. A method for operating the probe resulting in formation of spatially co-registered optical and acoustic images of the target. The probe is an invasive device for the examination of the internal vessels of the body. The layout of the optical and acoustic elements is different from the layout according to the current invention. Due to the different layout, the document cited is not able to capture co-registered surface-depth images of a planar surface, e.g., a skin surface.

Publication of Xiang Li et al., titled “High-resolution coregistered intravascular imaging with integrated ultrasound and optical coherence tomography probe”, American Institute of Physics, Applied Physics Letters 97, 133702, 2010 describes a multimodal invasive probe which is a superficial and depth imaging system suitable for the inspection of the inner surface of the vascular system, where two imaging systems transmit the focused laser and acoustic beams to the inspected area by a mirror placed at a 45° angle. The system creates the inspection image by using the reflected light and sound beams, which are displayed on the monitor of a computer. Altogether, the construction of the invention is fundamentally different from the current invention, since the optical and ultrasound beams are co-axially aligned, and both are redirected equally. In contrast, in the current invention, the two beams meet at a perpendicular angle, thus necessitating the acoustic mirror to allow the light to pass through in a manner that minimizes distortion.

WO 2020/148196 A1 describes an image registration system which contains a controller. The controller includes a memory which stores instructions, and a processor which executes the instructions. When executed, the instructions cause the controller to execute a process that includes obtaining a fluoroscopic X-ray image from an X-ray imaging system, and a visual image of a hybrid marker affixed to the X-ray imaging system from a camera system. A transformation between the hybrid marker and the X-ray imaging system is estimated based on the fluoroscopic X-ray image. A transformation between the hybrid marker and the camera system is estimated based on the visual image. Ultrasound images from the ultrasound system are registered to the fluoroscopic X-ray image from the X-ray imaging system based on the transformation estimated between the hybrid marker and the X-ray imaging system so as to provide a fusion of the ultrasound images to the fluoroscopic X-ray image. The solution does not mention the application of a transparent acoustic deflector. The optical camera used in the solution, rigidly fixed to the ultrasound transceiver unit, is not able to generate an optical image which is localised together with the ultrasound image; its function rather, is registration with a third imaging unit, namely an X-ray imaging unit. Thus, it is not designed and is not able to realise the purpose of the current invention.

U.S. Pat. No. 5,240,003 A describes a disposable intraluminal, i.e. in-cavity ultrasonic instrument for the invasive examination and/or treatment of hollow objects, e.g. blood vessels. In this invasive catheter arrangement, the ultrasound wave is deflected perpendicularly to its direction of propagation to capture a record of the blood vessel wall. From the document it is clear that no simultaneous 2D optical images of the examined surface are created through the acoustic mirror, since this layout does not make the compensation of the distortion possible. The motorised turning of the mirror poses further difficulties for integrating an optical camera into the system.

WO 2008/086613 A1 describes an invasive imaging probe for capturing images of mammalian tissues by using high resolution imaging, e.g. high frequency ultrasound and optical coherence tomography. The structure of the imaging probe combines the high resolution imaging possibilities of high frequency ultrasound (IVUS) and optical imaging, e.g. optical coherence tomography (OCT) with combined registration of optical and ultrasound imaging signals during scanning of the region of interest. Distortion compensation of optical and ultrasound imaging signals is not performed during the process. This layout, due to the characteristics of OCT imaging compared to 2D optical imaging (the light and ultrasound wave can propagate along almost the same route) works differently than the layout presented in the current invention; the technological background of the two solutions is considerably different. The detection of the probe movement in the cavity is a further important factor of imaging, while in the solution according to the current invention this does not play a role. The central idea of the invention in this document is that acoustic and optical imaging devices are rigidly connected to each other, at a constant, different angle; thus, although they examine different points of the medium in time, by a rotating scanning both modalities are able to generate images localised together. This central idea and the related design, although definitely beneficial for endoluminal (cavity) imaging, is more difficult to implement when images are made of a planar surface, such as in the case of images of the skin surface; thus, the present invention applies a different layout.

U.S. Pat. No. 4,375,818 A describes an ultrasonic diagnosis system which includes an ultrasound wave transmitting and receiving transducer, which is rigidly fixed within the distal end of a portion of an endoscope which is adapted to be inserted into a coeliac cavity. The transducer emits an ultrasonic wave from within the coeliac cavity, and directs it toward internal tissues of a physical body, thereby enabling an ultrasonic tomographic image to be obtained. The endoscope also contains an observation optical system, which permits the location of the ultrasonic transducer within the coeliac cavity to be visually recognized. The device is used during invasive interventions, and there is no co-registration between the ultrasound and optical image in the space near the device. The ultrasound and optical images are taken from different areas, the observation optical system is only used for determining the probe location, and it does not participate in combined imaging.

US 2013/0199299 A1 describes a process for the exact determination of the optical absorption coefficient by determining the acoustic spectra of the photoacoustic signals. Optical absorption is closely associated with many physiological parameters, e.g. the concentration and oxygen saturation of haemoglobin, and it can be used for quantifying the concentrations of non-fluorescent molecules. A sample is illuminated by, for example, a pulsed laser, and following the absorption of the optical energy, a photoacoustic pressure is generated with thermoelastic expansion. The acoustic waves then propagate, and are detected by a transducer. The optical absorption coefficient of the sample is quantified from the spectra of the measured photoacoustic signals. Factors such as bandwidth of the system and acoustic attenuation may affect the quantification, but are cancelled by dividing the acoustic spectra measured at multiple optical wavelengths. The device used during the procedure is not used for imaging but for determining the optical absorption coefficient based on the received ultrasound beam. The compensation developed for this is complex and difficult to implement at best. The layout presented tries to diminish the optical prism effect also demonstrated by us; nevertheless, its feasibility is questionable: in the case of the oil-based transparent acoustic deflector, it is not clear in what kind of medium the inventors envisage the reflection of sound waves and their further propagation to occur. Similarly to the above-mentioned US 2010/0268042 A1, the solution is specifically designed for complex and expensive optoacoustic imaging, during which the ultrasound element is only used in receive mode; also, the use of an oil-based mirror limits the coupling intermediary medium toa solid material, in contrast with the present invention, where the coupling medium can also be fluid, while the mirror is made of a solid material.

US 2012/0275262 A1 describes imaging systems, probes for imaging systems, and non-invasive imaging procedures. In one example, a probe for use with an imaging system contains a slit designed to spatially filter a light beam from a light source. The probe includes a focusing device designed to cylindrically focus the spatially filtered light beam into an object, and an ultrasound transducer array configured to detect a photoacoustic signal emitted by the object in response to the cylindrically focused light beam. Nevertheless, in this solution the extension to 2D optical imaging is technically not possible; it can cause difficulties that the laser beam has to pass through an acoustic lens. The light beam also passes through a prism. The extent of the optical distortion added this way could only be eliminated by a very special lens if we wished to capture 2D optical images. A further disadvantage is that the ultrasound beam has to pass through several reflectors, which decreases the acoustic signal-noise ratio. The solution according to the present invention is considerably more simple, which ensures that simultaneous imaging can widely be used. Similarly to the above-mentioned 2010/0268042 A1, the solution is specifically designed for complex and expensive optoacoustic imaging, during which the ultrasound element is only used in receive mode.

US 2003/058738 A1 describes a system where the fields of view of a real-time, three-dimensional, acoustic camera and a real-time, distance-measuring, more intensive electrooptical camera considerably overlap in the near vicinity of direct images of underwater objects that are close to each other. The system is typically mounted in an unmanned underwater vehicle, but may be used in other fixed or mobile configurations. The coupled fields of view are steerable in an arc around at least one axis over a large field of view with a servo-controlled rotating mirror system, while the vehicle or the target is moving or hovering. An automated target recognition system uses the multimodal images to provide enhanced target recognition and/or autonomous operation in unmanned missions. In the scope of the solution, ultrasound and optical imaging is performed, but in the case of optical imaging, the acoustic mirror is not used for 2D optical imaging in either case. In the central part of the first figure, a laser beam propagating through a sonar is presented.

US 2013/0217947 A1 describes systems, a method and devices for detecting, analysing, and treating lesions, e.g. skin cancer. Such a system may contain a high frequency ultrasound imaging device for taking images of the lesions. The system may also contain a processor that executes instructions stored in memory to perform operations, and the operations may include receiving a plurality of images of the lesion from the high-frequency ultrasound imaging device, rendering a three-dimensional model of the lesion using the plurality of images from the high-frequency ultrasound imaging device, and determining a treatment dosimetry based on the three-dimensional model of the lesion. The system may also contain a radiotherapy device to provide radiotherapy treatment to the lesion, where the radiotherapy treatment is based on the treatment dosimetry. The solution described in the document does not concentrate on the determination of the precise dimensions of the pathological lesion on the skin, but uses a two-in-one solution to determine the position and approximate size of the lesion on the skin, and then, on the basis of the data calculated from these, the dosing pattern of the radiotherapy treatment required. Thus, there is no information about the imaging and positioning method of the precise determination of the 3D lesion on the skin. Furthermore, no optical or other surface imaging is employed.

WO 2018/187626 A1 describes systems, devices and methods for detecting and treating skin conditions, e.g. skin cancers; more particularly, it relates to detection and superficial radiation therapy treatment of skin cancer. The system uses “Augmented Reality” (“AR”) display systems that help visualize radiation patterns and overall tumor shape/size, at least when setting up for radiotherapy treatment. The initial step of the solution is 3D imaging of the lesions on the skin, but its core concept is to precisely follow a pre-set radiation pattern implementation based on the 3D structure obtained this way, for which it uses augmented-reality-based goggles. The presentation of the 3D structure imaging is not detailed; its purpose is not to demonstrate 3D imaging that is as accurate as possible. It is obvious that the ultrasound scanner is a standard solution, different from the solution according to the current document, and no separate optical imaging is performed; moreover, the use of markers is not presented.

WO 2017/196496 A1 (SENSUS HEALTHCARE LLC, 2017 Nov. 16, A61N 5/10) describes a radiotherapy system including a radiotherapy component, a structural imaging component, a functional imaging component, and a workstation coupled to the radiotherapy component, the structural imaging component, and the functional imaging component. The workstation contains a processor which combines the structural image data and functional image data to produce a fused model for at least a portion of the region of interest, to generate a plan for radiotherapy treatment of the region of interest based on the fused model, and apply, via the radiotherapy component, the radiotherapy treatment. This solution describes in general terms that by combined registration of the images acquired by the two imaging systems, 3D imaging can be performed. Nevertheless, actual modifications in accordance with the invention are not described in the document. The application of surface markers are not covered by the document. Although combined registration of the images of the two imaging are described, no details are included in the document about the precision of 3D imaging acquired from these. In contrast, the goal of the solution in accordance with our invention is explicitly good quality 3D imaging, as well as precise registration of the surface and depth imaging modalities

EP 2680778 B1 (KONINKL PHILIPS N V, 2014 Jan. 8, A61B 90/00, A61B 34/20, A61B 8/08) describes an image registration system and method which includes tracking a scanner probe along a skin surface of a patient. Image planes according to the position are acquired. A three-dimensional volume of a region of interest is reconstructed from the image planes. A search of an image volume is initialized to determine candidate images to register the image volume with the three-dimensional volume by employing positional information of the scanner probe during image plane acquisition, and physical constraints of a position of the scanner probe. The image volume is registered with the three-dimensional volume. The invention is different from the current one, since the latter does not require a position sensor.

The description of the prior art documents is considered part of our description, in particular with regard to the definitions and compilations used.

According to the above, several state of art documents describe hybrid imaging systems. Some of these are imaging methods used for internal mapping of the internal parts of the body, mostly blood vessels, and are based on an imaging unit in the probe to be inserted into the body, where one imaging method is used for determining the position of the probe, while the other is used for actual imaging; therefore, these are not suitable for examining lesions of the skin.

For another part of the documents reviewed above, although they could be suitable for examining lesions of the skin, they do not provide a solution for very precise determination of the 3D shape of these lesions visible on the skin and extending into the layer under the skin. The goal of the invention is to eliminate the errors of the previous solutions, and to develop a device that is able to localise very precisely the ultrasound images relative to the coordinate system of a surface image or images, so that the ultrasound images can also be registered relative to each other easily. The present invention can also be used in other technical areas where volumetric imaging looks inside a material that is not fully visible to the bare eye (by ultrasound or other image modality). Optical imaging can be replaced by another imaging modality which is only able to see the surface of the object of interest. Furthermore, if an optical image is not taken, the invention is still able to generate 3D ultrasound images from the received 2D ultrasound images.

### Technical Problem

There is still a need, therefore, for devices and methods for providing very precise, low distortion volumetric localisation for the examination of in-depth and surface formations, e.g. for certain surgical procedures. In the case of the examination of skin, invasive solutions and inserting probes are not feasible as in the case of blood vessels. The registration of 2D surface-depth images was not implemented or was difficult in many cases, and often required manual image registration; besides, low distortion imaging of the appropriate combined imaging systems could only be achieved by very expensive, complex, photoacoustic specific mirror systems. The use of the currently known markers and the related procedures does not offer a solution either, since they do not have a shape and optical pattern based on which superficial and in-depth images could be unambiguously registered to each other.

### Solution to the Problem

Surprisingly, the inventors have found that by placing a transparent acoustic deflector at the proper angle and by using the appropriate medium, a multimodal imaging unit can be constructed, which, if placed in a tissue region of interest, as a result of the transparent acoustic deflector placed in the unit and the medium in the chamber, the optical beam arriving to the optical camera is forwarded from the surface region of interest with minimal distortion, just like the acoustic beam, which, on the other hand, is emitted perpendicularly to the region of interest, and propagates back to the transceiver unit of the depth imaging device. Surprisingly, we have found that for performing the combined registration of the 2D images obtained with different imaging systems in a well-defined manner, a marker may be utilized that serves as a coordinate system when fitting the 2D images onto each other, while its production costs are low.

No such prior art imaging device is known which is able to capture simultaneous, reliable superficial and depth images with great precision and in a low distortion way. Despite its simplicity and cost-effectiveness, the device in accordance with the invention provides a unique potential for fast and high precision diagnostics of skin diseases, and for following the patients'disease. Based on the state of the art it is known that in the case of a superficial and in-depth hybrid information set, automatic diagnostics can identify malignant tumors with almost 100% efficiency. Concerning that most of malignant melanocytic lesions pose a minimal risk if discovered in time, the version of the device designed for civil, personal use could dramatically decrease deaths and metastases due to skin cancer.

Both for recognising skin tumors and for following the treatment of various skin lesions, the comparison of superficial, and/or depth images of the same skin region, recorded at different times, plays an important role. By using the device presented in the invention and the related marker and procedure, it is possible to reproduce the superficial and depth images, i.e. they can be created by accurately targeting the same skin region, at several inspections at different times (even very far away from each other in time), regardless of the period elapsed between examinations.

When the device in accordance with the invention is complemented with a marker, 3D reconstruction of the ultrasound images becomes even more accurate. The main advantage of this is the planning of surgical operations, especially in the case of cutting out lesions from sensitive areas, since in such cases it is very important that minimal but still sufficient amount of tissue be removed, simultaneously minimising the probability of re-occurrence, and the quantity of unharmed tissues that need not be removed.

### SUMMARY OF THE INVENTION

A depth-surface imaging device is provided that contains an acoustic medium and a multimodal imaging unit with an appropriate medium for capturing low distortion 2D images, suitable for simultaneous capturing of optical and acoustic images, i.e. the unit for creating acoustic images does not cover the optical imaging space, since the optical and acoustic images are created at planes perpendicular to each other, and the distortion of the optical image is compensated, and the optical image is the localisation of the acoustic image according to the optical image coordinate system.

The depth-surface imaging includes a multimodal imaging unit, a data transmission device operably associated with the multimodal imaging unit and used for transferring the data to an information technology display device, where the obtained images are processed and displayed; and a display unit, on which the images can be projected and analysed.

The multimodal imaging unit for the depth-surface imaging device has an in-depth ultrasound imaging transceiver that emits an ultrasound beam towards an optically transparent acoustic deflector positioned at an angle of 45 degrees so that the acoustic deflector deflects an emitted ultrasound to a skin region of interest and a reflected ultrasound beam from the skin region of interest back to the ultrasound imaging receiver. The multimodal imaging unit also has an optical module with a light source positioned to direct an optical beam (a light beam) through the optically transparent acoustic deflector to a skin area of the skin region of interest. An optical camera sensor is positioned to receive an optical beam reflected from the skin area of the skin region of interest. An intermediary coupling medium is in contract with the ultrasound imaging transceiver and the optically transparent acoustic deflector. The ultrasound imaging transceiver, the optically transparent acoustic deflector and the intermediary coupling medium are hermetically enclosed by a cover which is provided with an acoustically and optically transparent access port for the aforesaid acoustic beams and optical beams.

The transparent acoustic deflector can be optically transparent or optically semi-permeable.

The intermediary coupling medium is made of a material able to transmit the ultrasound beam with minimal attenuation, and transmit the optical beam with low scattering, homogenously and transparently. Preferably, the intermediary coupling medium is selected from the group of distilled water, water-based jelly, preferably agar gel, mineral oil or mineral oil-based jelly, glass, plexiglass, and epoxy.

The images captured by the depth imaging device and the optical imaging device are created simultaneously, and are created in planes perpendicular to each other.

The intersection of the locations of the images forms a fixed line on the image displayed by the optical imaging device.

The present invention further relates to a depth-surface imaging device, wherein the distortion of the images captured by the optical imaging device is compensated.

The present invention further relates to a depth-surface imaging device, wherein the localisation of the images captured by the optical imaging device serves as a coordinate system for images captured by the depth imaging device.

The present invention further relates to a depth-surface imaging device, wherein the in-depth imaging system creates the image perpendicularly to the region of interest, which is allocated to the coordinate system defined by the marker shape and/or pattern, i.e. it is localised according to this.

The present invention also relates to a depth-surface imaging device, wherein the geometric arrangement of the in-depth and superficial images relative to each other, including the possible image distortions, is determined by a calibration measurement.

Additionally, the present invention relates to a method for depth-surface imaging, which includes the following steps:
capturing in-depth and superficial images of the region of interest with the depth-surface imaging device, optionally placing a marker on the region of interest so that it surrounds the region of interest;
registering the captured images in pairs based on the specific points of the coordinate system determined by the region of interest or by the fixed marker;
aligning the image pairs registered based on the coordinate system determined by the region of interest or by the fixed marker, which results in a set of the registered and aligned image pairs;
the set of the registered and aligned image pairs is displayed on the display unit, which results in a depth-surface 3D quality image.

The term medical imaging refers to techniques and procedures used for capturing images of the human body (or its certain parts) for clinical (medical procedures for discovering, diagnosing and examining various conditions) or scientific (including normal anatomic and physiological studies) purposes.

Photoacoustic imaging is a recently developed procedure using hybrid modality imaging based on the photoacoustic effect. It combines the advantages of optical absorption and ultrasound spatial imaging to achieve the highest possible resolution. More recent studies have proven that in vivo photoacoustic imaging is suitable for detecting occlusions in the blood vessels, for mapping blood oxygenation, for functional brain imaging and melanoma detection, etc.

Medical ultrasound examination applies, high frequency, high bandwidth sound waves (ultrasound) in the megahertz frequency range, which are reflected by the tissue to a different extent, which can be used to obtain images. Most people associate ultrasound with images of an embryo in a pregnant woman, although the scope of ultrasound examination is much broader than this. It is also used for imaging of abdominal organs, the heart, the breasts, the muscles, the tendons, the arteries and veins. It is less suitable for the examination of fine anatomic details than for example CT or MRI, but still it has several advantages, due to which it is an ideal tool in many situations, especially when the functioning of moving structures has to be examined in real time. Another great advantage is that it does not emit ionised radiation. If acoustic emission is properly chosen, no possible negative impacts are known in connection with its application, thus, this method seems fairly safe. Also, imaging is relatively cheap, and easy to implement. The real time images obtained can be used for controlled fluid drainage and tissue sampling. Doppler ultrasound examination makes it possible to assess arterial and venous flow.

Recently, by the development of technology, it is possible to create three-dimensional images by CT, MRI and ultrasound software for physicians. Traditionally, CT and MRI scans would only be able to produce two-dimensional static output. To achieve three-dimensional records, a very large number of scans must be performed, and these must be combined with certain computerised operations, to be able to create a three-dimensional model which can already be manipulated by the physician. Three-dimensional ultrasound images are also created in a very similar manner.

For acoustic imaging a transducer unit is required, which emits a sound wave, and converts the sound wave received as response to this to a signal that can be recorded. There are single element and multiple element transducers. In the transducers, typically one or more piezoelectric elements are used. As the result of electric excitation, each element creates an acoustic wave, and converts the reflected acoustic wave to an electric signal. In the case of several elements, the relative amplitude and timing of excitations, and when summing up the received signals, the relative weights and delays make it possible to modify the acoustic beam.

The most simple way of focusing is when a single fixed beam is created due to the shape of the transducer (by geometric focusing or an acoustic lens). Nevertheless, this has the disadvantage that this beam needs to be scanned somehow to enable imaging. If the transducer is composed of several, properly arranged elements, by delayed ultrasound emission of the transducer elements and by delayed summing up of the received signals, it is possible to scan the A-lines in several directions; this is called electronic scanning. If a single element transducer is used, depth information is recorded each time along one line, i.e. 1D (one-dimensional) information is read. If the elements are situated in a line (in other words, a linear transceiver is used), imaging can be performed over a plane with an acoustic lens (with each recording, a 2D image is read). If elements are situated on a plane, practically parallel with the examined surface, it is possible to scan a full 3D (three-dimensional) volume simultaneously.

### BRIEF DESCRIPTION OF DRAWINGS

Hereinafter, the advantageous embodiments presenting the invention are described by figures, wherein

FIG. 1 shows the placement of optical and acoustic imaging planes relative to each other during the examination.

FIG. 2 shows the lateral view of the multimodal imaging unit.

FIG. 3 shows the lateral view of another implementation of the multimodal imaging unit.

FIG. 4 shows the top view of the multimodal imaging unit when a single-element movable transceiving transducer unit is used.

FIG. 5 shows the top view of the multimodal imaging unit when a multiple-element movable transceiving transducer unit is used.

FIG. 6 shows the propagation direction of light in water-based intermediary coupling medium when a transparent acoustic deflector made of glass is used.

FIG. 7 shows the propagation direction of light when the intermediary coupling medium is made of a solid material.

FIG. 8 illustrates the geometric relationship between the optical and acoustic imaging planes within the multimodal imaging system.

FIG. 9 shows a sample image set for the implementation of displaying two-dimensional optical superficial and ultrasound depth image pairs registered together, and for demonstrating that the image pairs registered together are low distortions.

### DETAILED DESCRIPTION OF THE INVENTION

### Device for Depth-Surface Imaging

The most important element of the device is a multimodal imaging unit, which creates superficial 2D images and in-depth 2D images. This imaging unit can be controlled by the user with an input device, which, including but not restricted to, may be a smartphone or a personal computer.

The input device forwards the instructions of the user through a known communication channel to the data transmission device, which controls the imaging unit according to the instructions received; it sequentially starts and then stops imaging. In the data transmission device, necessarily a processor or FPGA (Field-Programmable Gate Array) functions as a processing and control unit, where the program being executed synchronises the stepping of the motor, which is responsible for the movement along linear guide, the electric excitation of the single element transducer unit, and the capturing of images by optical camera sensor.

The processing unit of the data transmission device organises the received signals, and, in the case of a single element transducer unit, registers the raw A-lines to a raw 2D acoustic image. After this, it concatenates the 2D acoustic image described earlier with the optical image or series of optical images captured by the optical unit.

The resulting concatenated images are forwarded by the data transmission device to the input device, where a suitable software performs the final processing of the images, which, in the case of ultrasound images, mainly, but not limited to it, means traditional ultrasound image processing techniques, e.g. averaging, frequency-spectrum-based Fourier range filtering, envelope detection, logarithmic transformation and smoothing. Optionally, final processing may also be performed in the processing unit of the data transmission device, thus speeding up processing time.

When a marker is used, the sets of superficial and in-depth images are converted by the software running on the input device to a hybrid three-dimensional image, where a 2D or 3D acoustic image is also registered under the superficial optical image, depending on whether the user captured one or more 2D acoustic images. Registration of superficial and in-depth images is performed by detecting and measuring the optical pattern of the marker and the shadow that was created during in-depth imaging, caused by the material of the marker, and matching the dimensions and physical position of the marker or by using an inverse function or by searching the pre-generated map. The images are displayed to the user by the screen of the input device.

A good example for the communications channel between the input device and the data transmission device is the USB communications protocol.

When a transducer unit is moved manually instead of a motor, the data transmission device performs concatenation of the 2D depth acoustic images in a way described in WO 2016/207673 A8. In the case of using a transducer line transceiver, the processing unit of the data transmission device and the connected beam creating software and hardware synchronise beam forming with optical imaging. In such cases, raw 2D acoustic image is available right after the end of beam forming.

### Multimodal Imaging Unit

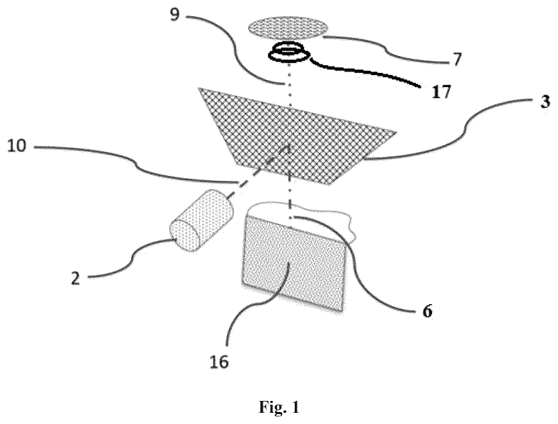

As can be generally seen in FIG. 1, such a multimodal imaging solution is illustrated. In this general configuration, light beam 9, emitted by an illuminating light source positioned within the device, illuminates the skin region of interest 6. The light beam 9 is reflected from the skin surface and undergoes refraction at an optically transparent acoustic deflector 3.

The optically transparent acoustic deflector 3 deflects acoustic beam 10 while allowing light beam 9 to pass through. Acoustic beam 10 is generated by transducer unit 2 and directed toward the region of interest 6, forming acoustic image region 16.

An optical module 17 guides the optical beam toward optical sensor 7, where the corresponding optical image of the skin surface is detected.

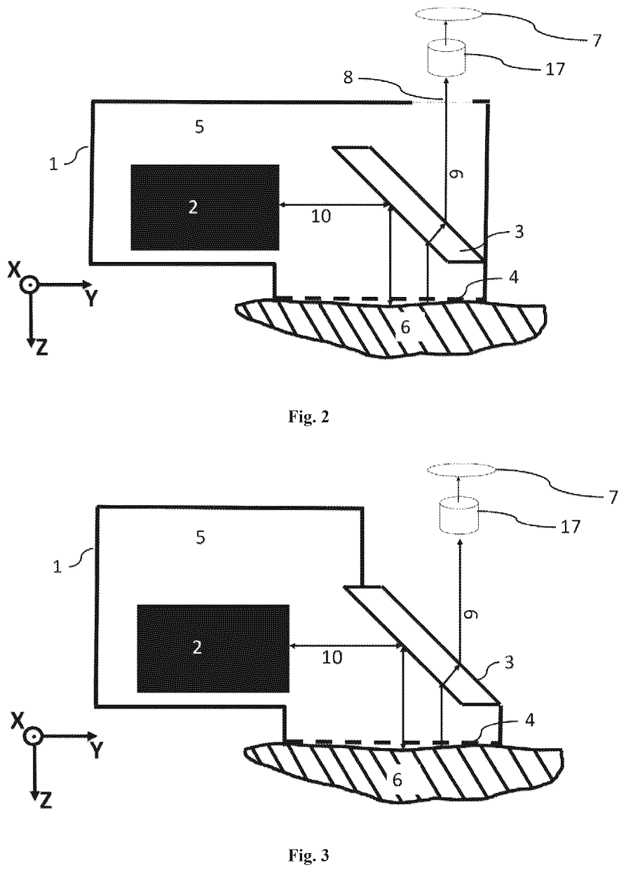

In the multimodal imaging unit shown in FIG. 2, within hermetically sealed cover 1 there is a transducer unit 2, from which the acoustic wave is reflected towards an area of interest to the skin region of interest 6 from an optically transparent acoustic reflector 3, situated on a plane at 45° to the surface of transducer unit 2 through an external membrane 4 that covers an acoustically and optically transparent access port. The external membrane 4 is transparent and permeable both optically and acoustically, but provides hermetic sealing of the cover. It keeps the liquid intermediary media 5 in the internal chamber of the multimodal imaging unit, where the internal chamber is enclosed by cover elements 1, 4, and 8. Transducer unit 2 may be a single element transceiver. In this case, transducer unit 2 has to move along the trajectory defined by the skin surface, so that the 2D cross-section of the skin surface can be displayed at the end of imaging. In the more simple case, a series of 1D transceiver units is placed along the trajectory covered, thus, it is not necessary to move transducer unit 2.

Thus, the optically transparent acoustic deflector 3 deflects the acoustic beam 10 on the one hand, and lets light beam 9 through on the other hand, which is collected by optical module 17, and optical camera sensor 7 can take 2D images. Optical camera sensor 7 is preferably located outside the hermetic cover 1 together with optical module 17, and detects surface of skin region of interest 6 through an optically transparent cover element 8, where the optically transparent cover element 8 is optically transparent and covers an access port for light beam 9. If intermediary coupling medium 5 surrounds the optically transparent acoustic reflector 3, the extent of optical distortion is negligible, and the material of optically transparent cover element 8 may be identical to the material of optically transparent acoustic reflector 3. The light beam 9 illuminates the skin area of the skin region of interest 6 by an illuminating light source placed within the device is reflected from the skin area and undergoes refraction on transparent acoustic deflector 3, leaves cover 1 through the optically transparent cover element 8 on the access port, and reaches optical camera sensor 7 through optical module 17, which is practicably a collector lens (system), which route defines the propagation path of light beam 9. The acoustic wave moves from transducer unit 2 to the direction of transparent acoustic deflector 3, is reflected-and deflected-off it, and enters the examined skin region of interest 6, where it is reflected, and then being reflected again on transparent acoustic deflector 3, and travels back to the transducer unit, where a signal matching the detected acoustic wave is created; this path determines the propagation path of acoustic beam 10.

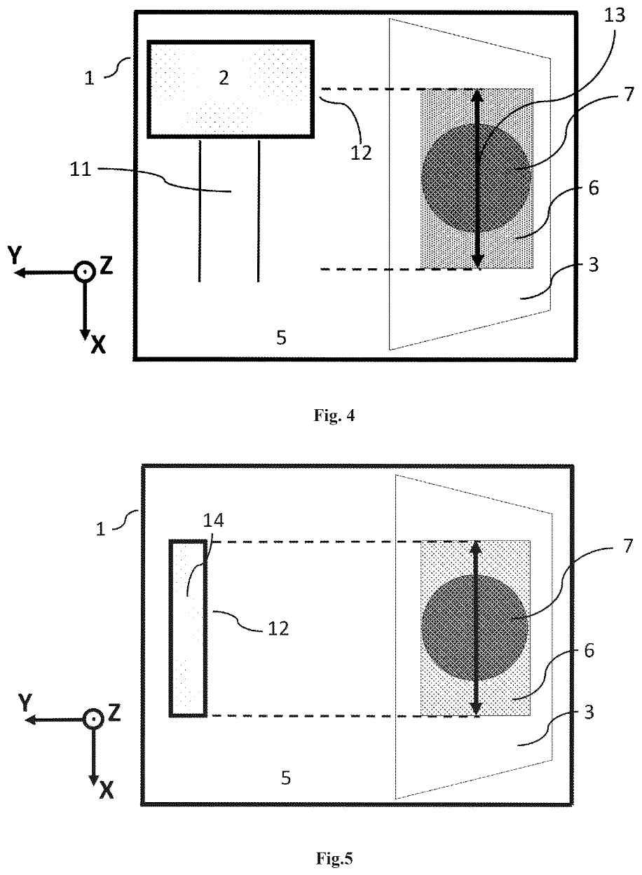

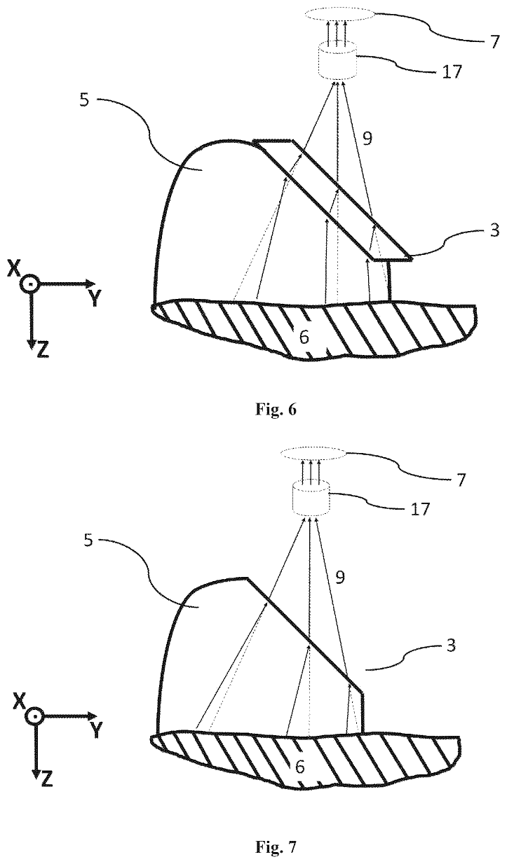

In another embodiment of the multimodal imaging unit shown in FIG. 3, transducer unit 2 is situated within hermetically sealed internal cover 1 of the device, from where the acoustic wave is reflected to the skin region of interest 6 from an optically transparent acoustic reflector 3, placed in a plane at 45° to the surface of transducer unit 2, through an external membrane 4. The external membrane 4 is transparent both optically and acoustically, but provides hermetic sealing of cover 1. It keeps the liquid intermediary coupling medium 5 in the internal chamber of the apparatus. Transducer unit 2 may be a single element transceiver unit. In this case, transducer unit 2 has to move along the trajectory defined by the skin region of interest 6, so that a 2D cross-section of the skin region of interest 6 can be displayed at the end of imaging (FIG. 4). The top view of the arrangement is shown in FIG. 4. Acoustic transducer unit 2 moves in the X direction on linear guide 11. It can be moved manually or by a motor. The centre of transducer unit 2 is always between the two dashed lines; thus, it scans the end of the double arrow in the centre line of the rectangle representing the skin region of interest 6, at Z depth, creating a 2D ultrasound image in the X-Z direction. At the right side of the Figure, the path of the light from the corresponding skin surface is the following: first it passes through external membrane 4, then it also passes through the transparent acoustic deflector 3, then it also passes through the optically transparent cover element 8, reaching optical camera sensor 7 through optical module 17, while in the arrangement in FIG. 3, passing through optical module 17 after transparent acoustic deflector 3, it immediately reaches optical camera sensor 7.

In such cases, transducer unit 2 is movable; thus, a mechanism is used according to this. In the more simple case, a series or array of 1D transceiving transducer elements 2 is placed along the trajectory covered, thus, it is not necessary to move transducer unit 2. The top view of the arrangement is displayed in FIG. 5. The x-direction linear array of transducer elements 14 scans the end of the double arrow in the centre line of the rectangle representing the skin region of interest 6, at z depth, creating a 2D ultrasound image in the x-z direction. At the right side of the figure, the path of the light from the skin region of interest 6 is the following: first it passes through external membrane 4, then through the optically transparent acoustic reflector 3. In the layout in FIG. 2, it also passes through the optically transparent cover element 8, and then it reaches optical camera sensor 7 through optical module 17. In the layout in FIG. 3, the light, after exiting transparent acoustic deflector 3 and passing through optical module 17, immediately reaches optical camera sensor 7.

Thus, the optically transparent acoustic reflector 3 deflects the acoustic beam on the one hand, and lets light pass through on the other hand, which is collected by optical module 17 to optical camera sensor 7, which takes 2D photos. Optical module 17 and optical camera sensor 7 are practicably located outside hermetic cover 1, and the material of cover 1 in front of it must be optically transparent. If intermediary media 5 surrounds the optically transparent acoustic reflector 3, the extent of optical distortion is negligible, and the material of an optically transparent cover element in front of the camera may be identical to the material of optically transparent acoustic reflector 3, provided that it is optically completely transparent.

The critical element of the unit is a chamber making optical-ultrasound imaging possible, which is enclosed by cover 1 and its elements 4 and 8 over the access ports. The chamber is capable of transmitting ultrasound and optical beams simultaneously for synchronous multimodal imaging.

The chamber is filled with water in one possible embodiment. This ensures that ultrasound waves can propagate in it. Thus, in pulse-echo imaging the ultrasound wave emitted at the transceiver head of transducer unit 2 can propagate to the skin region of interest 6 and back. In pulse-echo imaging, the acoustic wave travels along a straight path both ways in current practice. In the current layout, the acoustic wave, during its way back and forth, is also reflected from transparent acoustic deflector 3. The material of transparent acoustic deflector 3 is designed in a way that its so-called characteristic acoustic impedance (hereinafter; Z value) is sufficiently different from the internal material of the chamber. A material suitable for this is glass.

With the following approximate Z value, the suitability of transparent acoustic deflector 3 is demonstrated as an example in one embodiment, so that by providing reflection, the acoustic wave can further travel perpendicularly to the original direction of propagation. The extent of reflection is determined by the reflection coefficient, which describes the ratio of the reflected wave amplitude and the incident wave amplitude, and which can be described with the equation (Z₂−Z₁)/(Z₁+Z₂), where Z₁ is the Z value of the original medium, and Z₂ is the Z value of the new medium. The Z value of water is 1.5 MRayl, the Z value of glass is 13 MRayl; thus, nearly 80% of the incident wave is reflected, and travels further in the required direction. The water-based medium can be replaced by other liquids of similar acoustic and optical characteristics (e.g. to a liquid, agar-based gel) if required.

The part of the acoustic wave entering the glass undergoes refraction, and is reflected at the second boundary surface (typically when contacting water or air), and can enter the water again at the water-glass boundary. Although these secondary waves can disturb imaging by creating artefacts, the double refraction of the acoustic wave, both as it travels to the skin surface and also as it travels back, practically diverts the acoustic wave to such an extent that it will be less sensitive to the echo arriving from a different angle due to the limited angular extent of the beam of the transceiving transducer 2; therefore, the contribution of these secondary waves is negligible.

Concerning optical imaging, optical distortion is negligible in the case of FIG. 2. In the case of FIG. 3, the optical beam travels through the water, mirror, and air layers before the image is captured by an optical camera. The water-air boundary surface, separated by a 45° mirror, can cause a prism effect, which may distort the optical image; thus, without compensation, may render optical-acoustic registration by transparent acoustic deflector 3 inaccurate. For solving this, there are two solutions. First, the distortion can be compensated. Since the distortion can be described by an affine transformation using an augmented matrix, the distortion can be compensated with the inverse matrix. There are several possibilities for determining the distortion; thus, it can, for example, be calculated analytically by using the laws of refraction; it can be simulated by “ray tracing” applications, or it can be empirically calculated by taking photographs of a known optical pattern (which can even originate from an image of the examination using the current marker, but also from an image of a quadratic lattice made before the examination). Second, the extent of distortion can be decreased in two ways. One is to place an optical matching material between transparent acoustic deflector 3 and optical camera sensor 7, which decreases the refraction index difference. Such a material can be for example oil, so that light beams can enter the lens. Another possible option is to place a prism between optical module 17 and the chamber, which counteracts distortion. These solutions for decreasing distortion can even be used when an alternative chamber layout, described in the paragraph below, is used.

The above description of the chamber seems the most practical layout currently in the case of high frequency ultrasound, where it is important that the media that mediates the ultrasound attenuates it to the least possible extent, for which water is an appropriate choice. Nevertheless, for the layout in FIG. 3, the intermediary coupling medium can be replaced with a solid one, according to the following considerations. Since the finite thickness of transparent acoustic deflector 3 may attenuate the ultrasound beam and also cause distortion in optical imaging, intermediary coupling medium 5 can be cast from a solid material, so that it can even form an integral part of the acoustic transducer unit 2 following the piezo layer, or it can be interfaced, fixed or glued by an intermediate material to transducer unit 2. This material can be for example epoxy, which has relatively low acoustic attenuation, and is optically transparent. In such cases, transparent acoustic deflector 3 and internal intermediary media 5 may even be of the same material. Thus, the acoustic wave can pass on with almost full reflection (since the Z value of air is negligible compared to solid materials). Nevertheless, it must be considered that the refraction coefficient of the indicated materials will be greater than that of water, thus, the extent of optical distortion may increase.

While it can be seen from the design of the chamber that the acoustic and optical images can be taken together, their location is perpendicular to each other; thus, the identification of the intersection line of the two images, and by this the localisation of the ultrasound image according to the optical coordinate system requires further explanation. As can be seen in FIG. 9, the optical image depicts the skin surface of the skin region of interest 6, and the position of the acoustic image is projected onto the optical image as a line. The location of this line can be estimated on the one hand from the geometric location of acoustic and optical imaging devices, supplemented with the physical and information technology compensation of the optical image distortion that may potentially arise, as has been discussed above. An optical-acoustic marker can also be used either during a calibration measurement preceding the examination, but also, an ultrasound test object containing a line formation can be used, which ensures that when an expected acoustic formation appears, the line causing it can be located on the optical image.

### EXAMPLE 1

In this example we describe how the optical-ultrasound multimodal imaging device in accordance with the invention creates the co-registered 2D optical and 2D ultrasound images of the skin surface.

We fitted the multimodal imaging unit of the device onto the skin region of interest 6. We started the recording by pushing a button on the input device or on the screen. The input device transmitted the instruction to the data transmission device. This latter synchronously started the surface imaging, the electric excitation of the in-depth imaging device, and the motor in the multimodal imaging unit which moves transducer unit 2 along a linear guide 11 as shown in FIG. 4. Ultrasound beams travelling in intermediary coupling medium 5 were reflected from the direction of the surface 12 of transceiving transducer from transparent acoustic deflector 3 at an angle of 90 degrees to the skin region of interest 6 through the acoustically and an optically transparent external membrane. The acoustic waves reflected and collected from the skin region of interest 6 were propagated backwards along this same path to transducer unit 2 (according to FIGS. 1 and 2). In case of a superficial, optical imaging, the light from the skin region of interest 6 propagates through the acoustically and optically transparent external membrane 4 into the multimodal imaging unit, propagated further through the optically transparent intermediary media 5, and passed through the transparent acoustic deflector 3 in a straight line with negligible distortion. It passed through the intermediary media 5 on the other side of the transparent acoustic deflector 3. The light passed through the hermetic cover 1 of the device through optically transparent cover element 8 towards optical camera sensor 7, collected through optical module 17.

After movement in one or the other direction through the linear trajectory in FIG. 4 (the covered distance is the same as the trajectory length of acoustic beam), the processing unit of the data transmission device organised the received acoustic signals: the raw A lines were registered to a raw 2D B mode ultrasound image. After this, the 2D ultrasound image described earlier was concatenated with the optical image or series of optical images captured by the optical unit.

The concatenated images obtained this way were forwarded by the data transmission device sequentially, after moving from one end point to another end point (transducer unit 2) to the input device, where the software being executed on it performed the final image processing, thus creating the traditional 2 dimension B mode ultrasound images. Finally, the images were displayed to the user by the screen of the input device.

### EXAMPLE 2

This example describes how the optical-ultrasound multimodal imaging unit in accordance with the invention creates several 2D optical and 2D ultrasound images of the skin region of interest 6, and concatenates these optical-ultrasound image pairs, by using a marker, into co-registered 2D optical and 3D ultrasound images.

We fitted a marker onto the skin region of interest 6. In the case of the lesion shown in described in FIG. 9, the pathological lesion was situated roughly in the vicinity of the centre of the marker, and the pattern of the marker did not cover any important parts of the lesion.

The concatenated images obtained this way were transmitted by the data transmission device sequentially, after moving from one end point to another end point (transducer unit 2) to the input device, where the software being executed on it performs final image processing, thus creating the traditional 2 dimension B mode ultrasound images.

The series of optical-ultrasound images were transferred by the software into a common coordinate system determined by the pattern of the marker. This is due to the fact that the optical pattern of the marker can be detected in the optical images, and the ultrasound images are already registered to the optical images. Another characteristic of a marker can also be used: the cross-section image of the marker can be unambiguously identified by the acoustic transceiver, and by this the software running on the input device can unambiguously identify the position of the image in the marker coordinate system. In this case, registration of the superficial and in-depth images was performed by detecting and measuring the shadow that was created by the optical pattern of the marker and in-depth imaging caused by the material of the marker, and matching the dimensions and physical position of the marker, or by using an inverse function or by searching the pre-generated map.

Thus, when a marker was used, the series of superficial and in-depth images were converted by the software running on the input device to a hybrid three-dimensional image, where the 2D or 3D acoustic image was also registered under the superficial optical image, depending on whether the user captured one or more 2D acoustic images.

Finally, the images were displayed to the user by the screen of the input device.

### EXAMPLE 3

This example shows the efficiency and 2D visualisation of the co-registration of the surface-depth image pair captured by using the device described in Examples 1 and 2.

One method of two-dimensional visualisation of the combined registration of surface-depth image pairs was that the two 2D images were displayed side by side or one under the other, and the position of the plane of one image was indicated in the other image. In the current example, a linear section indicated in the superficial (optical) image the trajectory of reflected acoustic beam on the examined skin region of interest 6, in other words, the intersection line of the superficial image and the in-depth (in this example ultrasound) image situated at a 90 degree image plane relative to it. In the current example, we were able to zoom in on arbitrary parts of the 2D acoustic image displayed on the screen of the electronic device displaying the images. The displaying of the image pair registered together, in accordance to zooming in and out, followed such a user interaction in real time in a way that the size and position of the marker section displayed in the optical image was always adjusted to the size and position of the in-depth image part currently displayed. FIG. 9 shows an example of such a co-registered image pair with different image parts of the same depth image.

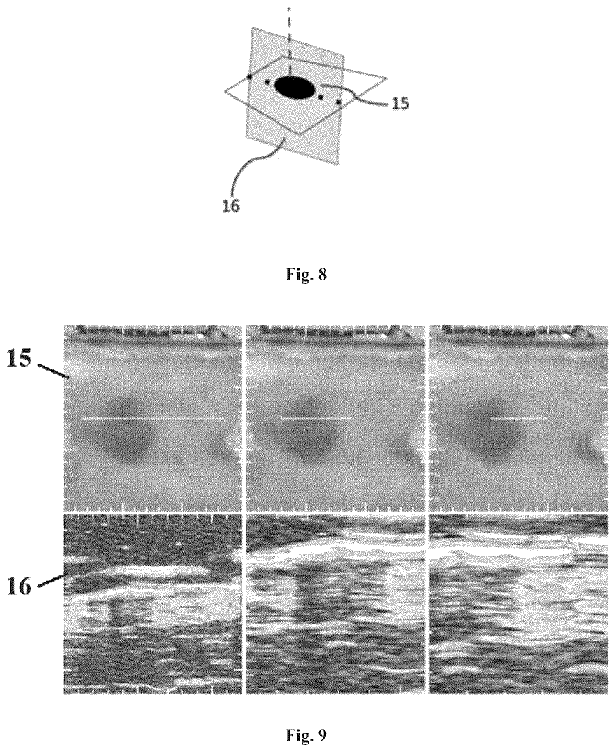

FIG. 8 shows the intersection of two image regions: optical image region 15 corresponds to an region of interest, and an acoustic beam generates acoustic image region 16, which extends substantially perpendicularly to optical image region 15. The two image regions 15 and 16 intersect each other, and the line of intersection can be displayed on optical image region 15. This line assists the user in identifying the exact location of acoustic image region 16 within the area of interest.

The example presented in FIGS. 8 and 9 also illustrates how imaging of the superficial (optical) and 2D acoustic image registered together can be implemented with minimal distortion by using the devices and procedures presented in design examples 1 and 2.

The invention described herein is not limited to the advantageous examples presented in detail, but further variations, modifications and developments are also possible within the scope of protection defined by the claims.

1. A multimodal imaging unit for a depth-surface imaging device which comprises
an in-depth ultrasound imaging transceiver;
an optically transparent acoustic deflector positioned at 45 degrees to an ultrasound beam emitted by the in-depth ultrasound imaging transceiver to direct an emitted ultrasound beam towards a skin region of interest and to direct a reflected ultrasound beam to the in-depth ultrasound imaging transceiver;
an optical module having a light source positioned to direct through the optically transparent acoustic deflector an emitted optical beam to a skin area of the skin region of interest;
an optical camera sensor positioned to receive through the optically transparent acoustic deflector a reflected optical beam from the skin area of the skin region of interest;
an intermediary coupling medium in contact with said ultrasound imaging transceiver and said optically transparent acoustic deflector; and
a cover hermetically enclosing said ultrasound imaging transceiver, said optically transparent acoustic deflector, and said intermediary coupling medium and defining an acoustically and optically transparent access port for said acoustic beams and said optical beams.

2. The depth-surface imaging device according to claim 1, wherein the transparent acoustic deflector is optically transparent, and in relation to acoustic imaging, acoustically reflective.

3. The depth-surface imaging device according to claim 1, wherein the depth imaging transceiver unit is an ultrasound transceiving transducer unit.

4. The depth-surface imaging device according to claim 3, wherein the intermediary coupling medium comprises at least one material selected from the group consisting of a distilled water, a water-based jelly, a mineral oil, mineral oil-based jelly, glass, plexiglass, and epoxy resin.

6. The depth surface imaging device according to claim 1 wherein the in-depth imaging transceiver unit is an ultrasound transceiving transducer unit.
